(19) United States
(12) Patent Application Publication
(10) Pub. No.: US 2016/0128883 A1
(43) Pub. Date: May 12, 2016

(54) ADJUSTABLE FURNITURE

(71) Applicant: INTEGRATED FURNITURE TECHNOLOGIES LIMITED, Cheltenham (GB)

(72) Inventor: DALE ROBERTSON, CHELTENHAM (GB)

(73) Assignee: INTEGRATED FURNITURE TECHNOLOGIES LIMITED, Cheltenham (GB)

(21) Appl. No.: 15/001,574

(22) Filed: Jan. 20, 2016

Related U.S. Application Data
(63) Continuation of application No. PCT/GB2014/000274, filed on Jul. 8, 2014.
Application No. PCT/GB2014/000274 is a continuation-in-part of application No. 14/971,231, filed on Dec. 16, 2015.
Application No. 14/971,231 is a continuation of application No. 13/390,985, filed on Apr. 18, 2012, now Pat. No. 9,241,571.

(30) Foreign Application Priority Data
Aug. 18, 2009 (GB) 0914436.1
Oct. 23, 2009 (GB) 0918685.9

(51) Int. Cl. A61G 7/015

(52) U.S. Cl. CPC A61G 7/015

(57) ABSTRACT

An adjustable article includes a frame, a one movable support pivotally mounted for adjustment with respect to the frame, curved guides connected to respective opposite lateral sides of the movable support section, bearings connected to respective opposite lateral sides of the frame, the curved guides arranged to run on the bearings to permit adjustment about a pivot axis defined by the centre of curvature of the curved guides, and captivating means for maintaining engagement of the guides on the bearing means through the range of adjustment. The captivating means comprises, on each lateral side of the frame, a means for resisting sideways lateral movement of the respective curved guide with respect to the frame, a roller bearing is fixed in relation to the frame and arranged to bear on the respective curved guide to maintain the curved guide in the plane of the bearing means associated with that guide.

### CROSS REFERENCE TO RELATED APPLICATIONS

This application relates to and claims §1.53(b) priority as a continuation of Ser. No. PCT/GB2014/000274 filed Jul. 8, 2014, the entire contents of which are incorporated herein by reference, which in turn claims priority from GB Ser. No. 1313002.6 filed Jul. 20, 2013.

This application also relates to and claims priority as a §1.53(b) continuation-in-part of U.S. Ser. No. 14/971,231 filed Dec. 16, 2015, which in turn is a continuation of U.S. Ser. No. 13/390,985 filed Apr. 18, 2012 issued as U.S. Ser. No. 9,241,571 on Jan. 26. 2016 which is a §371 national phase of Ser. PCT/GB2010/001565 filed Aug. 18, 2010, the entire contents of which are incorporated herein by reference, which in turn claims priority from GB Ser. No. 0914436.1 filed on Aug. 18, 2009 and GB 0918685.9 filed on Oct. 23, 2009.

### FIGURE SELECTED FOR PUBLICATION

FIG. 6

### BACKGROUND OF THE INVENTION

This invention relates to adjustable furniture and in particular concerns adjustable beds having adjustable body-support sections which can be moved to adjust the configuration of the bed.

Adjustable beds are known, for example, from US2002/0174487 which discloses a hospital bed having adjustable back and thigh sections. The hospital bed of US2002/0174487 comprises a frame having a pair of parallel and spaced apart first and second side frame members: a mattress support deck including an adjustable back section having first and second sides; a fixed seat section located adjacent to the back section and an adjustable thigh section located adjacent to the seat section, and movable relative to the seat section to increase the length of the thigh section as the thigh section is raised relative to the frame. First and second curved tubes are coupled to respective first and second sides of the back section. A plurality of rollers are coupled to the first and second side frame members, with the rollers being configured to support the first and second curved tubes to permit movement of the curved tubes and the back section relative to the frame. A linear actuator is disposed beneath the back section and coupled to the first and second tubes to move the back section from a horizontal position to an elevated position relative to the frame. Two concentric arcuate tubes are provided on each side of the bed which have a radius of curvature centred on a location which emulates the natural hip pivot of a person lying on the mattress of the bed. The tubes are secured between three rollers on each side of the bed. Two rollers are located on a bottom side of the radially outer tube, that is to say radially outwards thereof, and the third roller is located on a top side of the radially inner tube. A pair of cross-members extend between the tubes. The arrangement provides a so called shear-less pivot mechanism in which the adjustable back section pivots about the natural hip point of the person on the bed.

The arrangement disclosed in US2002/0174487 may be considered heavy, robust and mechanically complex. This structure, while suitable for hospital beds, does not readily provide an arrangement that is suitable for more lightly used domestic furniture adjustable beds, where other design considerations, such as weight and cost, come into play.

An adjustable bed particularly suitable for domestic furniture applications is described in WO2011/048384. This bed comprises a mattress support deck having a plurality of mattress support sections, including a movable back support section, a fixed seat section adjacent to the back support section, a movable thigh support section adjacent the seat section and a movable foot or lower leg support section adjacent and hinged to the thigh support section. The back and thigh support sections are mounted with respect to the base to allow angular adjustment of their relative positions to alter the configuration of the bed. Linear actuators are provided for moving each of the movable sections to effect angular adjustment of the bed. A pair of load-bearing arcuate members are spaced apart on opposite lateral sides of both the back and thigh sections. The load bearing members project from the underside of the respective support sections and are each provided with bearings arranged to run on a respective curved support provided in or on a respective side panel of the base. The load bearing members are rigidly connected together by a suitable cross-member on the underside of the respective support sections. Each cross member provides a suitable attachment point for one end of a linear actuator. The arrangement provides a robust box-section type construction, the four sides of which are provided by the support section, typically a panel of board material, the two load bearing members on opposite sides of the support section and the cross-member. This construction provides for rigidity that resits twisting of the structure and hence maintains alignment of the bearings and respective curved support guides in the side panels of the base.

### ASPECTS AND SUMMARY OF THE INVENTION

There is a requirement for an adjustable bed which is mechanically less complicated than hitherto known designs and which has attendant weight and cost advantages.

According to an aspect of the present invention there is provided an article of adjustable furniture comprising: a frame, at least one movable support section pivotally mounted for angular adjustment with respect to the frame, a pair of curved guides connected to respective opposite lateral sides of the said movable support section, bearing means connected to respective opposite lateral sides of the frame, said curved guides being arranged to run on said bearing means to permit said angular adjustment about a pivot axis defined by the centre of curvature of said curved guides, and captivating means for maintaining engagement of said curved guides on said bearing means through said angular adjustment.

The above aspect of the invention provides a simple arrangement for adjustable furniture, particularly adjustable beds of the aforementioned type. Engagement of the curved guides and bearing means is readily maintained by the captivating means in all adjustment configurations. This can reduce weight and cost in such arrangements as less complex structures may be implemented. In particular the above aspect of the invention contemplates embodiments without stiffening elements such as cross-members mentioned above. This can achieve significant weight and cost advantages without compromising performance and durability. This is a particular consideration in the domestic furniture industry where manufacturing cost is often critical to a product's success in the marketplace.

Preferably the captivating means comprises, on each lateral side of the frame, means for resisting sideways lateral movement of the respective curved guide with respect to the frame. In this way sideways movement due to say over or uneven loading can be avoided ensuring the curved guides and associated bearing means are maintained in engagement in all adjustment configurations of the item of furniture

In preferred embodiments, said captivating means comprises, on each lateral side of the frame, at least one roller fixed in relation to the frame and arranged to bear on the respective said curved guide to maintain the said curved guide in the plane of the said bearing means associated with the said guide. Conveniently, the fixed roller or rollers provide support for the weight of the adjustable sections and the body weight of the user when supported on the article of furniture. The rollers maintain low friction contact between the movable parts which readily provides for smooth adjustment and efficient load transfer to the frame in use.

Preferably, the curved guides comprise a channel, preferably a U-section channel, and said bearings means are arranged to run in said channel. In this way the channels conveniently provide a guide track for the bearings in which the bearings are encapsulated and thereby shielded in the article of furniture.

On each side of said frame, the bearing means preferably comprises a pair of spaced apart rollers arranged to run in the curved channel. This provides for even load distribution and load transfer between the curved guides and the bearings at two spaced apart locations along the path of the guides. The two bearings may also provide respective end limits or stops for limiting the travel of the guides at each end of the range of adjustment.

Preferably, the captivating means is positioned between the pair of rollers. In this way any applied loads which would otherwise cause the guides to twist or distort can be resisted in an equal and balanced way since the distance between the captivating means and the respective rollers may be substantially the same. In more preferred embodiments the captivating means is positioned substantially midway between the pair of rollers.

Preferably, the article of furniture is an adjustable bed. Thus, the above aspect of the invention contemplates an adjustable bed in which the adjustable support sections are arranged as described above.

In preferred embodiments, the at least one movable support section includes at least a movable back support section movable between a horizontal position and an inclined elevated position relative to the frame. The present invention therefore contemplates embodiments in which the bed has at least an adjustable back support section which may be raised or lowered, preferably between a horizontal position and a raised inclined position as is well known in the art.

In preferred embodiments, the at least one movable support section may also include a movable thigh support section movable between a horizontal position and an inclined elevated position relative to the frame. Thus embodiments are contemplated with or without an adjustable thigh section.

Preferably, the adjustable bed of the above aspect of the invention further comprises a fixed mattress support seat section adjacent the back support section, the fixed mattress support seat section preferably being fixed with respect to the frame. The above aspect of the invention therefore contemplates embodiments having known type arrangements of adjacent fixed and adjustable support sections.

In preferred embodiments the frame comprises a fixed floor standing base section and a movable intermediate support carriage movable longitudinally with respect to the base section, with the movable support section(s) being mounted with respect to the intermediate support carriage to allow angular adjustment thereof to alter the configuration of the bed, and the intermediate support carriage being movably mounted on or in relation to the fixed floor standing base for translational movement with respect to the base, and having means for providing co-ordinated translational movement of the intermediate support carriage with angular adjustment of the back section. In this way the above aspect of the invention contemplates so called “zero wall” or “wall-hugger” embodiments is which the support sections move rearwards with the movable carriage when the back support section is raised, and forwards when the back section is lowered towards its horizontal position, with the angular adjustment of the back section being co-ordinated with the translational movement of the intermediate support carriage of the frame. This feature is particularly advantageous in adjustable beds of the aforementioned type as it permits the user to remain close to other bedside items such as a bedside table or cabinet when the back rest is raised, which would otherwise move the user forward and away from the headboard end of the bed.

In preferred embodiments the intermediate support carriage comprises a pair of elongate parallel side panels. This provides a suitable mounting for the bearing means for mounting the adjustable support section as previously described.

In preferred embodiments the intermediate support carriage comprises a sub-assembly moveable within the said floor standing base section.

In preferred embodiments the intermediate support carriage is movably mounted with respect to the base by guide means. The guide means preferably comprises bearing means carried by the intermediate support carriage and a guide provided on or in the said floor standing base section.

In preferred embodiments the guide means is linear, preferably inclined, most preferably inclined in a forward direction towards a toe end of the bed.

In preferred embodiments, the floor standing base section comprises first and second spaced apart parallel side frame members. This provides for a robust construction and which may preferably be in the form of a rectangular structural frame.

In preferred embodiments actuator means is arranged to apply the adjustment force substantially to the underside of the moveable support section to which it is attached. In this way the actuator loads may be minimised by increasing the perpendicular distance between the pivot axis of the respective support section and the point of application of the actuator load.

In preferred embodiments the actuator means comprises of at least one electric motor driving an extended threaded spindle. In preferred embodiments, actuator means, preferably a single linear actuator, is associated with each of the relatively moveable support sections so that each may be operated independently. In preferred embodiments the actuator is disposed substantially horizontally with the frame on the underside of the respective adjustable support sections, and more preferably the or each linear actuator remains substantially horizontal throughout is range of extension.

The above aspect of the invention readily enables the weight of the user to be supported by the article of furniture with the load bearing structure of the furniture being integrated in such a way that the weight carried by the furniture is readily transferred to the frame. The arrangement of the load bearing curved guides and associated bearing means readily enables the adjustable support sections to be moved, independently if necessary, about their respective pivot axis, which may be offset from the base and positioned appropriately to avoid compression of adjacent soft cushion parts or mattress carried by the support sections.

In preferred embodiments the pivot axis of the or each movable support section is positioned above the frame in a plane offset from the top edge thereof. The offset nature of the pivot axis or axes can substantially eliminate interference of the respective support sections when they move with respect to one another as the pivot axis may be positioned at a common hinge position between adjacent support sections. In preferred arrangements where the support sections include a compressible cushion or other compressible support means on their upward facing surface interference at the respective adjacent ends can be readily avoided.

In preferred embodiments the pair of load bearing curved guides lie substantially parallel with respective lateral side members of the frame. This arrangement readily provides for a compact arrangement in which the load bearing curved guides are positioned closely adjacent to the respective lateral side members away from other moving parts of the furniture, including the actuator means which may preferably be located within the structure of the frame.

The bearing means carried by the frame may be of any appropriate kind, for example roller bearings mounted on a shaft.

Each pair of curved guides may additionally be connected together by a respective cross-member, in addition to the respective support section, with the cross-member preferably extending on the underside of the support section. Such a cross member will have the effect of stiffening the moveable structure and also provide an attachment point for connection to a powered actuator if further stiffening is required.

According to another aspect of the invention there is provided an article of adjustable furniture such as an adjustable bed comprising: a frame, at least one movable support section pivotally mounted for angular adjustment with respect to the frame, a pair of curved guides connected to respective opposite lateral sides of the movable support section, bearing means connected to respective opposite lateral sides of the frame, the curved guides being arranged to run on the bearing means to permit angular adjustment about a pivot axis defined by the centre of curvature of the curved guides, and captivating means for maintaining engagement of the curved guides on the bearing means through the range of angular adjustment of the article of furniture. Preferably the captivating means comprises, on each lateral side of the frame, a means for resisting sideways lateral movement of the respective curved guide with respect to the frame, preferably a roller bearing is fixed in relation to the frame and arranged to bear on the respective curved guide to maintain the curved guide in the plane of the bearing means associated with that guide.

### BRIEF DESCRIPTION OF THE DRAWINGS

Various embodiments of the present invention will now be more particularly described, by way of example only, with reference to the accompanying drawings; in which:

FIG. 1 is a perspective view from the front and above of an adjustable bed according to an embodiment of the invention.

FIG. 2 is the same perspective view of the bed in FIG. 1 with the mattress support sections shown in ghost outline.

FIG. 3 a side elevation view of the bed of FIGS. 1 and 2.

FIG. 4 is a plan view from below of the bed of FIGS. 1 to 3.

FIG. 5 is an end elevation view from the rear of the bed of FIGS. 1 to 4.

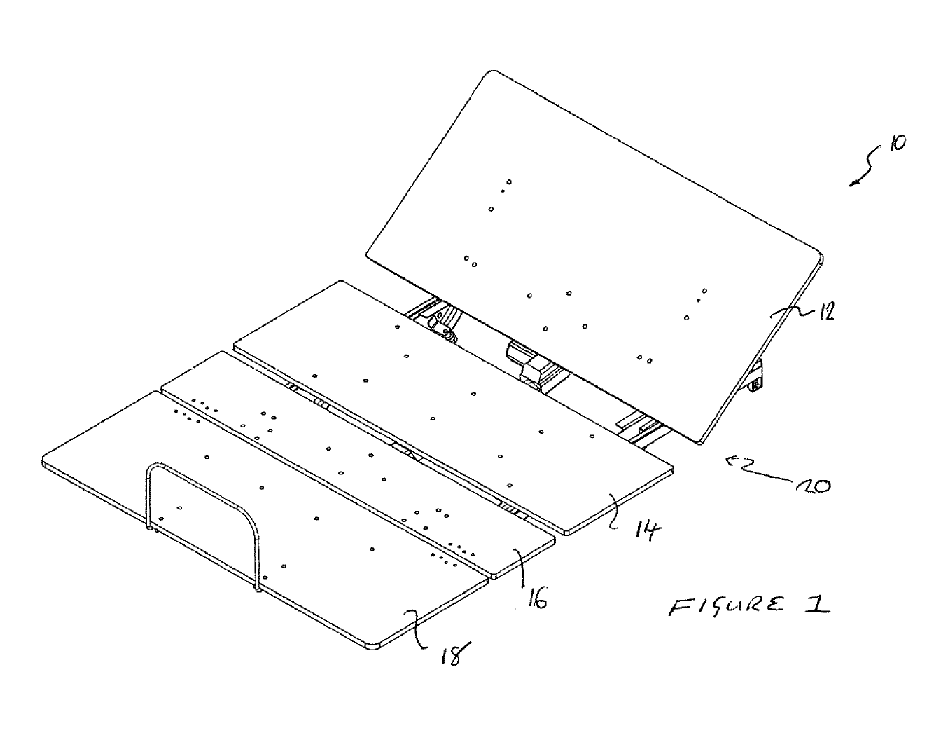

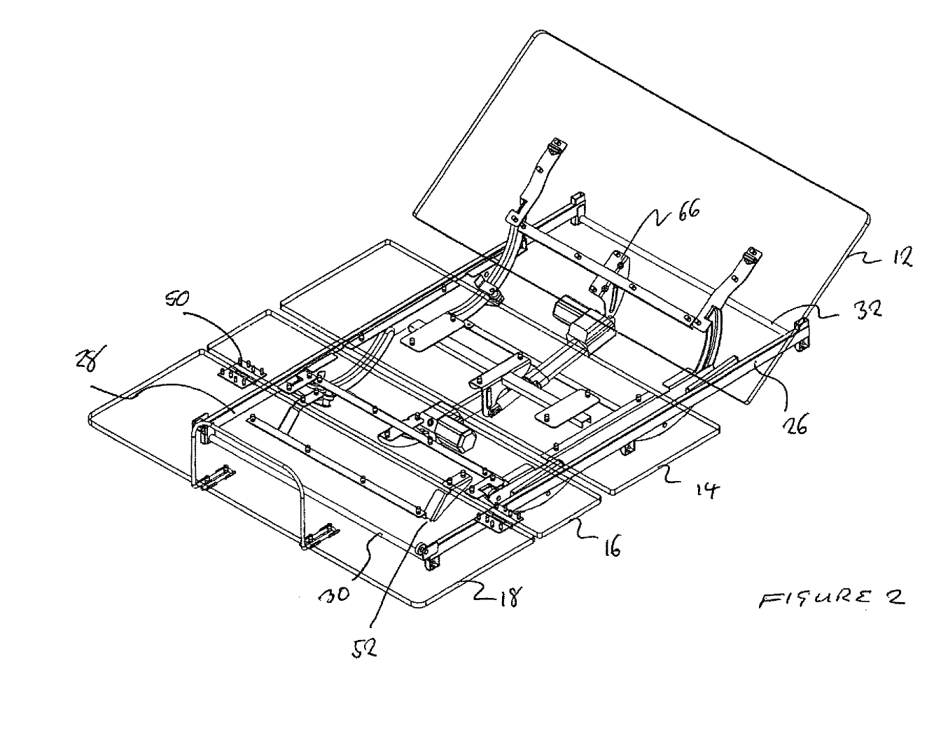

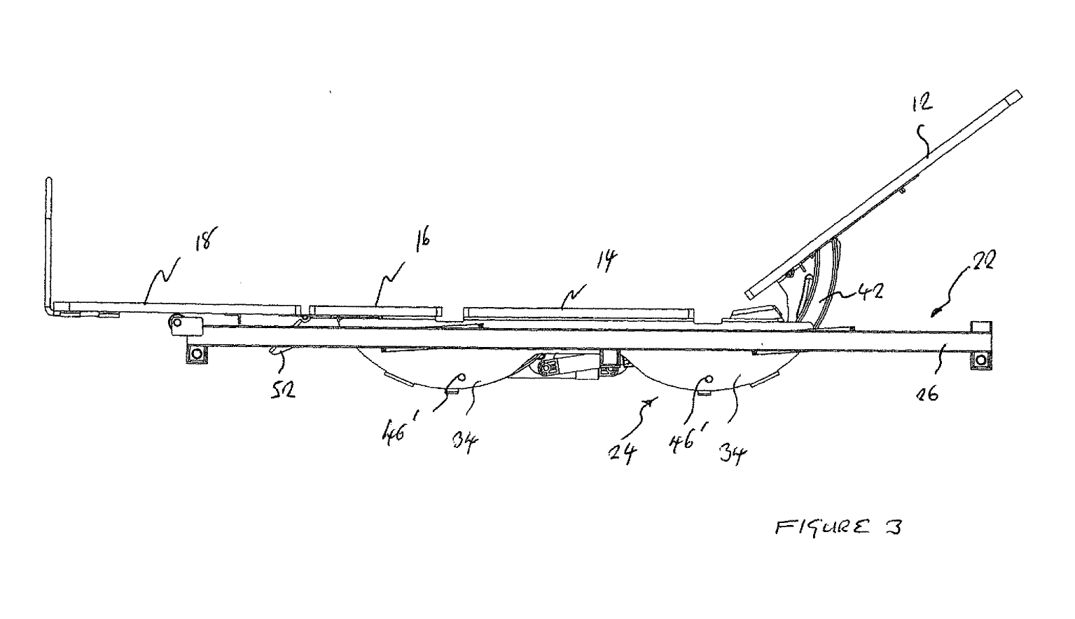

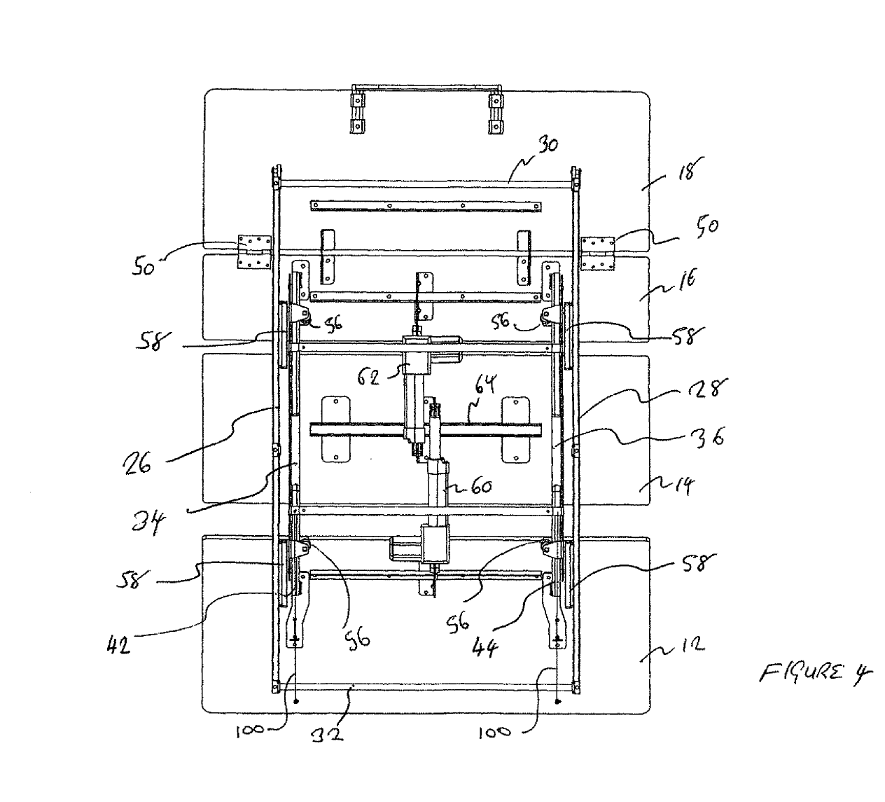

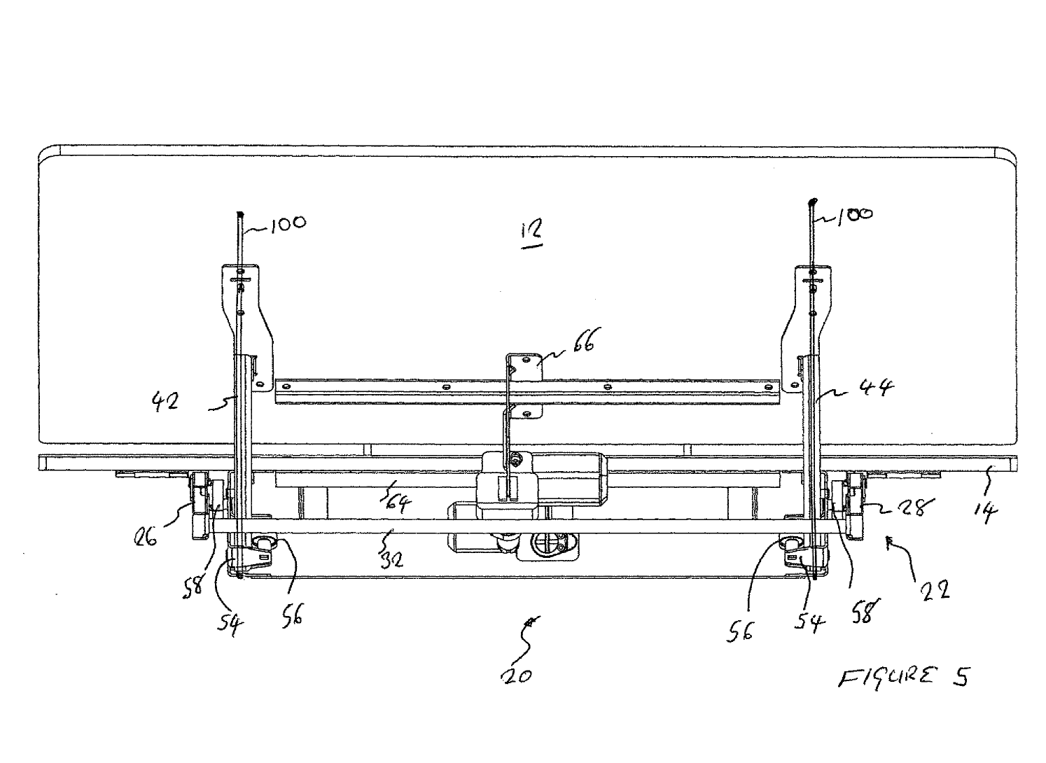

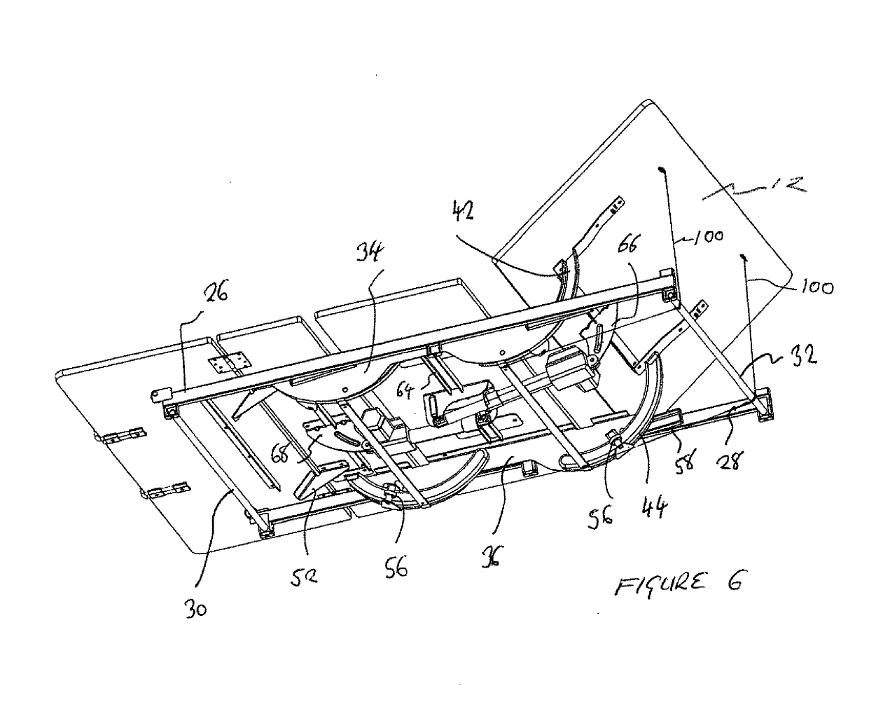

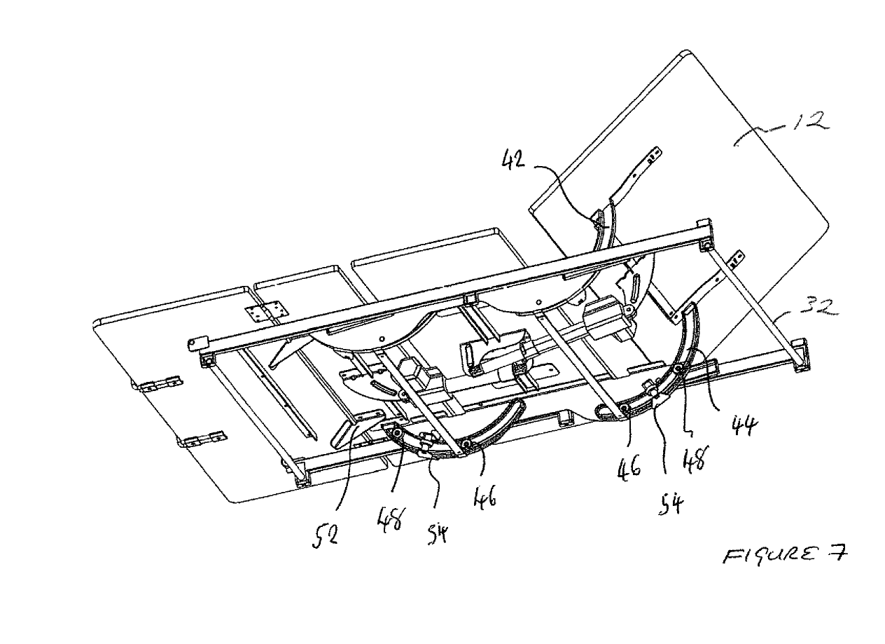

FIG. 6 is a perspective view of the bed of FIGS. 1 to 5 from below.

FIG. 7 is the same perspective view of the bed of FIG. 6 with specific parts shown in ghost outline.

### DETAILED DESCRIPTION OF THE PREFERRED EMBODIMENTS

Reference will now be made in detail to embodiments of the invention. Wherever possible, same or similar reference numerals are used in the drawings and the description to refer to the same or like parts or steps. The drawings are in simplified form and are not to precise scale. The word ‘couple’ and similar terms do not necessarily denote direct and immediate connections, but also include connections through intermediate elements or devices. For purposes of convenience and clarity only, directional (up/down, etc.) or motional (forward/back, etc.) terms may be used with respect to the drawings. These and similar directional terms should not be construed to limit the scope in any manner. It will also be understood that other embodiments may be utilized without departing from the scope of the present invention, and that the detailed description is not to be taken in a limiting sense, and that elements may be differently positioned, or otherwise noted as in the appended claims without requirements of the written description being required thereto.

Various operations may be described as multiple discrete operations in turn, in a manner that may be helpful in understanding embodiments of the present invention; however, the order of description should not be construed to imply that these operations are order dependent.

In the drawings same reference numbers are used for same or similar parts throughout.

Referring to the drawings, FIGS. 1 to 7 schematically show an adjustable bed 10 according to an embodiment of the present invention. The bed 10 comprises a mattress support deck having four adjacent mattress support sections including an adjustable back/head support panel 12, a fixed seat support panel 14, an upper leg or thigh support panel 16 and a foot and lower leg support panel 18. The panels 12, 16 and 18 are adjustably mounted on a support frame 20, best shown in FIG. 2. The seat section 14 is fixed in relation to the frame 20. The panels may include upholstered cushions/pads or the like for supporting a mattress (not shown) positioned on top of the cushions or pads, alternatively a mattress may be positioned directly on top of the panels 12-18.

In FIGS. 1 to 7 the bed 10 is shown in an upright configuration with the back support section panel 12 raised and inclined with respect to the fixed seat section panel 14 and the adjustable support section panels 16 and 18 which lie flat and horizontal with the adjacent seat section panel 14. In this position the bed is configured to support a person in a raised seated position. In their lowered position the panels lie substantially flat on top of the frame 20 to support the user horizontally in a lying down position. In the lowered position the adjustable support panels 12 16 and 18 combine with the seat section panel 14 to define a substantially flat horizontal platform. As mentioned, the various support panels may each have a mattress support cushion (not shown) which combine to provide a mattress foundation for supporting a suitable mattress to provide a so called “soft edge” adjustable bed. The present invention also contemplates arrangements where the frame 10 is integrated in a divan type bed foundation structure. The bed 10 is a double bed but the present embodiment contemplates beds of many different widths including standard single size beds to much larger doubles.

As can best be seen in FIG. 2, the frame 20 comprises a generally rectangular structure, preferably constructed of metal but other materials may be used for various parts, in addition to or instead of metal, including board type material, for example engineering plastic, MDF, timber or other fibre type board for example. The frame 20 includes an outer frame 22 in the form of a fixed floor standing base section and an inner frame 24 in the form of a movable intermediate support carriage which is movable longitudinally with respect to the fixed outer frame 22. The adjustable support section panels 12, 16 and 18 are mounted on the inner frame 24, in a manner which will be described in more detail below, for adjustment of their relative positions relative to the frame to alter the configuration of the bed.

The outer frame 22 comprises a pair of elongate parallel lateral side frame members 26, 28 on respective opposite sides of the bed. The side frame members extend longitudinally substantially the entire length of the bed and are joined together near their respective ends by cross-members 30, 32 to form a rectangular box type structural support frame. The side frame members may be constructed of suitably dimensioned box section metal tube and the cross-members of circular section metal tube. The outer frame 22 is provided with upstanding legs (not shown) at each of the corners of the rectangular frame structure. The outer base support frame 22 thereby constitutes the floor standing part of the bed 10 and in this respect the outer frame 22 may stand directly on the floor or be provided with castors, feet or the like at the base of the respective legs as is well known in the art.

The movable intermediate support carriage 24 is mounted within the interior region of the base support frame 22 on the underside of the support section panels 12, 14, 16 and 18. The intermediate support carriage 24 can best be seen in the drawings of FIG. 2 where the panels 12, 14, 16 and 18 are shown in ghost outline only, and the drawings of FIGS. 3 to 7. The intermediate support carriage 24 comprises a pair of elongate parallel side panels 34, 36 disposed adjacent the lateral left and right hand side frame members 26 and 28 of the outer base support frame 22. The panels 34 and 36 are symmetrically identical such that the mounting arrangement on one side of the bed is the same as the other. The panels 34 and 36 each comprises a pair of spaced apart semi-circular sections at their respective longitudinal ends which linked together by a narrower straight mid-section. The semi-circular sections depend downwards below the respective side frame members 26, 28. As can best be seen in FIG. 7 each semi-circular section includes bearings means on which the respective adjustable support section panels are mounted. A pair of roller bearings 46, 48 are mounted on bearing pins 46′, 48′ at circumferentially spaced locations on the respective semi-circular sections of the of the side panels 34, 36. Bearing 46 and the associated pin is positioned at the 6 o'clock position on both semi-circular sections and bearing and pin 48, 48′ at a forward position (e.g. 7 o'clock) on the forward semi-circular section and at a rearward position (e.g. 5 o'clock) on the rearward semi-circular section, thus the bearings 46, 48 are spaced approximately 30 to 45 degrees apart on a circumference centred on the centre of the respective semi-circular sections. The roller bearings 46, 48 are located on the inward facing side of the respective side panels 34, 36, that is to say the side of the side panels facing the interior of the underside of the bed.

The panels 34, 36 are joined together by a pair of parallel tie bars 38, 40 which are spaced apart longitudinally along the length of the bed. The panels 34 and 36 are preferably constructed from a metal sheet material, preferably steel sheet material of an appropriate gauge.

The back support section panel 12 is pivotally mounted to the intermediate support carriage 24 by a pair of load bearing support members in the form of curved arcuate U-section guides or radial arms 42, 44 connected to and extending from the underside of the panel 12 on respective opposite lateral sides thereof. The load bearing support members or curved guides 42, 44 are spaced apart and located at laterally spaced positions on the panel 12 so that they lie substantially adjacent to the respective side panels 34, 36. The open sides of the U-section guide channels face the respective inward facing sides of the adjacent side panels 34, 36 and accommodate the respective roller bearings 46, 48. The curved guides have the same radius of curvature and lie on the same circumference as the respective bearings 46, 48 so that the bearings locate, and are held captive in, the respective open U-section channels of the curved guides and thereby provide a suitable rotational mounting for the back support section panel about a respective pivot axis defined by the centre of curvature of the respective curved guides 42, 44. This can best been seen in the drawing of FIG. 7 where the respective curved guides 42, 44 are shown in ghost outline only to reveal the roller bearings 46, 48 located in the open channels of the curved guides.

The thigh section support panel 16 is similarly pivotally mounted to the intermediate support carriage by a pair of load bearing support members in the form of curved arcuate U-section guides or radial arms 42, 44 connected to and extending from the underside of the panel 16 on respective opposite lateral sides thereof. The load bearing support members or curved guides 42, 44 are spaced apart and located at laterally spaced positions on the panel 16 so that they lie substantially adjacent to the respective side panels 34, 36. The open sides of the U-section guide channels face the respective inward facing sides of the adjacent side panels 34, 36 and accommodate the respective roller bearings 46, 48. The curved guides have the same radius of curvature and lie on the same circumference as the respective bearings 46, 48 so that the bearings locate, and are held captive in, the respective open U-section channels of the curved guides and thereby provide a suitable rotational mounting for the thigh support section panel about a respective pivot axis defined by the centre of curvature of the respective curved guides 42, 44.

The seat section support panel 14 is fixed with respect to the intermediate support carriage immediately between the back and thigh support panels 12 and 16. The lower leg section support panel 18 is pivotally connected to the thigh support panel 16 along their respective adjoining edges by hinges 50. A pair of so called knee-break angled brackets 52 are attached to the underside of the panel 16 at the edge adjacent to the lower leg/foot rest panel 18 so that the panel 18 has a maximum degree of angular adjustment with respect to the panel 16 when the panel 16 is raised. The angled face of the bracket 52 acts as an abutment stop when it comes into engagement with the underside of the panel 18 when panel 16 is raised to a position where engagement occurs. Thus, further raising of the panel 16 causes the panel 18 to lift completely above the frame 22 and remain at a pre-determined angle relative to the panel 16.

As can best be seen in FIGS. 6 and 7 captivating means 54 are provided at the location of each curved guide 42, 44 for maintaining engagement of the curved guide on the respective roller bearings 46, 48. The captivating means 54 comprises a roller bearing 56 mounted on a bracket that is fixed to the respective side panel 34, 36. The roller bearing 56 bears against the inward facing surface of the respective guide 42, 44 to maintain the curved guide in the plane of the bearings 46, 48 and thereby prevent sideways lateral movement of the curved guide with respect to the adjacent side panel 34, 36. Each bearing 56 is mounted between the bearings 46, 48 at each respective location. In particular the bearing 56 is positioned midway between the respective bearings 46, 48 so that a substantially equal force is applied to the curved guide at the location of the bearings 46, 48. This is beneficial in terms of preventing distortion of the curved guide in use due to uneven loading or weight distribution on the respective movable panels 12, 16 and 18. Each bearing 56 is mounted in a plane that is perpendicular and tangential to the respective guide so that it runs freely along the radial face of the curved guide facing the interior of the frame on the underside of the bed.

A previously mentioned the movable intermediate support carriage 24 is mounted within the interior region of the base support frame 22. A pair of inclined linear guide channels 58 is provided on the inward facing surfaces of the respective side frame 26, 28 members at longitudinally spaced locations on respective opposite sides of the bed. A first pair of guide channels 58 is positioned towards the back support section 12 of the bed and a second pair in the region of the thigh support section panel 16. The guides 56 are fixed to the respective side frame members 26, 28 and receive roller bearings (not shown) fixed to the respective side panels 34, 36. A pair of straps 100, 100 are fixed at one end to the respective side panels 34, 36 and at the other to the panel 12 and are looped around the cross-member 32 so that when the back support section panel 12 is moved from its horizontal position to a raised position, tensioning of the straps cause the movable intermediate support carriage 24 to move rearward with respect to the outer frame 22, and forwards when the panel 12 is lowered, thereby providing the bed with “zero-wall” or “wall-hugger” functionality.

Movement of the panels 12, 16 and 18 is effected by linear electrical actuators 60, 62 mounted on the underside of the bed within the space envelope of the inner frame. Linear actuator 60 has a first end secured to a cross-member 64 on the underside of the panel 14 substantially at a mid-point along the length of the panel 14, and a second end secured to a bracket 66 depending from the underside of the panel 12. Similarly linear actuator 62 has a first end also secured to the cross-member 64, and a second end secured to a bracket 68 depending from the underside of the panel 16. Thus panel 12 is raised and lowered by respective extension and retraction of actuator 60 and panel 16. with attached panel 18, is raised and lowered by respective extension and retraction of actuator 62.

It will be understood that while the illustrated embodiment of FIGS. 1 to 7 concerns a bed the present invention also contemplates embodiments wherein the article of furniture is an adjustable chair, for example a chair having a recliner function in which the back rest is angular adjustable relative to a seat section and adjustment is achieved in a similar manner as hereinbefore described.

Having described at least one of the preferred embodiments of the present invention with reference to the accompanying drawings, it will be apparent to those skills that the invention is not limited to those precise embodiments, and that various modifications and variations can be made in the presently disclosed system without departing from the scope or spirit of the invention. Thus, it is intended that the present disclosure cover modifications and variations of this disclosure provided they come within the scope of the appended claims and their equivalents.

1-18. (canceled)

19. An article of adjustable furniture comprising:
a frame, at least one movable support section pivotally mounted for angular adjustment with respect to the frame;
a pair of curved guides connected to respective opposite lateral sides of said movable support section;
bearing means connected to respective opposite lateral sides of the frame;
said curved guides being arranged to run on said bearing means to permit said angular adjustment about a pivot axis defined by the centre of curvature of said curved guides; and
captivating means for maintaining engagement of said curved guides on said bearing means through said angular adjustment.

20. An article of adjustable furniture as claimed in claim 19, wherein:
said captivating means further comprises, on each lateral side of the frame, means for resisting sideways lateral movement of the respective curved guide with respect to the frame.

21. An article of adjustable furniture as claimed in claim 20, wherein:
said captivating means further comprises, on each lateral side of the frame, at least one roller fixed in relation to the frame and arranged to bear on the respective said curved guide to maintain said curved guide in the plane of said bearing means associated with said guide.

22. An article of adjustable furniture as claimed in claim 21, wherein:
said curved guides comprise a channel, preferably a U-section channel, and said bearings means are arranged to run in said channel.

23. An article of adjustable furniture as claimed in claim 22, wherein:
on each side of said frame, said bearing means comprises a pair of spaced apart rollers arranged to run in said curved channel.

24. An article of adjustable furniture as claimed in claim 23, wherein:
said captivating means is positioned between said pair of rollers.

25. An article of adjustable furniture as claimed in claim 24, wherein:
said captivating means is positioned substantially mid-way between said pair of rollers.

26. An article of adjustable furniture, according to claim 25, wherein:
said article of furniture is an adjustable bed.

27. An article of adjustable furniture, according to claim 26, wherein:
said at least one movable support section includes at least a movable back support section movable between a horizontal position and an inclined elevated position relative to the frame.

28. An article of adjustable furniture, according to claim 27, wherein: said at least one movable support section also includes a movable thigh support section movable between a horizontal position and an inclined elevated position relative to the frame.

29. An article of adjustable furniture, as claimed in claim 28, further comprising:
a fixed mattress support section adjacent said back support section, said fixed mattress support section being fixed with respect to said frame.

30. An article of adjustable furniture, according to claim 27, wherein:
said frame further comprises:
a fixed floor standing base section and a movable intermediate support carriage movable longitudinally with respect to the base;
said movable support sections being mounted with respect to the intermediate support carriage to allow angular adjustment thereof to alter the configuration of the bed;
the intermediate support carriage being movably mounted in relation to said fixed floor standing base for translational movement with respect thereto; and
means for providing a co-ordinated translational movement of said intermediate support carriage with angular adjustment of said back section.

31. An article of adjustable furniture, according to claim 30, wherein:
said intermediate support carriage comprises a pair of elongate parallel side panels.

32. An article of adjustable furniture, according to claim 31, wherein:
said intermediate support carriage comprises a sub-assembly moveable within said floor standing base section.

33. An article of adjustable furniture, according to claim 33, wherein:
said intermediate support carriage is movably mounted with respect to said base by a guide means.

34. An article of adjustable furniture, according to claim 33, wherein:
said guide means further comprises a bearing means carried by said intermediate support carriage and a guide provided on or in said floor standing base section.

35. An article of adjustable furniture, according to claim 34, wherein:
said guide means is linear.

36. An article of adjustable furniture, according to claim 34, wherein:
said floor standing base section comprises a first and a second spaced apart parallel side frame member.

37. An adjustable bed, comprising:
a frame including a fixed base and a movable intermediate support carriage movably mounted in relation to the fixed base for translational movement with respect thereto;
a mattress support deck having a plurality of mattress support sections including at least one adjustable support section including an adjustable backrest support section pivotally mounted at a head end of the bed for angular adjustment with respect to the intermediate support carriage; and
tensioning means connected between the adjustable backrest support section and the intermediate support carriage such that the intermediate support carriage is movable with respect to the base in response to an angular adjustment of the back support section.

38. An adjustable bed as claimed in claim 37, wherein:
the tensioning means further comprises:
a flexible connection line having a first end fixed in relation to the intermediate support carriage and a second end fixed in relation to the adjustable backrest support; and
wherein the connection line is tensioned in use by movement of the backrest towards a raised position, which movement drives the intermediate support carriage rearward relative to the base.

39. An adjustable bed as claimed in claim 38, wherein:
the connection line is tensioned against an engagement means at a location spaced from the pivot axis of the backrest support.

40. An adjustable bed as claimed in claim 38, wherein:
said connection line is tensioned against an engagement means fixed in relation to the base and at a location towards the lower end of the back support.

41. An adjustable bed as claimed in claim 38, wherein:
the connection line comprises at least one selected from a group consisting of: a strap, belt, and a cable.

42. An adjustable bed as claimed in claim 38, wherein:
the connection line is disposed in a region on the underside of the bed.

43. An adjustable bed as claimed in claim 37, wherein:
said intermediate support carriage further comprises:
a pair of elongate parallel side members.

44. An adjustable bed as claimed in claim 43, wherein:
the elongate parallel side panels are joined together.

45. An adjustable bed as claimed in claim 37, wherein:
the intermediate support carriage further comprises:
a sub-assembly moveable within the floor standing base section.

46. An adjustable bed as claimed in claim 45, wherein:
the intermediate support carriage is movably mounted with respect to said base by guide means.

47. An adjustable bed as claimed in claim 46, wherein:
the guide means further comprises:
a bearing means carried by the intermediate support carriage and a guide provided on said floor standing base section.

48. An adjustable bed as claimed in claim 47, wherein:
the guide means is linear.

49. An adjustable bed as claimed in claim 48, wherein:
the guide means is inclined rearwardly so that the intermediate support carriage is raised as it translates rearwards with respect to the base.

50. An adjustable bed as claimed claim 38, wherein:
the base section further comprises first and second spaced apart parallel side frame members.
